(19) United States
(12) Patent Application Publication
(10) Pub. No.: US 2025/0146328 A1
(43) Pub. Date: May 8, 2025

(54) Locking Device for Connecting Two Assemblies

(71) Applicant: Fidlock GmbH, Hannover (DE)

(72) Inventors: Florian Hüwel, Hannover (DE); Joachim Fiedler, Hannover (DE)

(21) Appl. No.: 18/832,222

(22) PCT Filed: Dec. 12, 2022
(86) PCT No.: PCT/EP2022/085410

§ 371 Date: Jul. 23, 2024

(30) Foreign Application Priority Data
Feb. 28, 2022 (DE) 10 2022 104 735.0

(51) Int. Cl. E05B 47/00; E05B 19/14; E05B 63/14

(52) U.S. Cl. CPC E05B 47/0038; E05B 19/14; E05B 63/143

(57) ABSTRACT

A locking device for connecting two assemblies to one another includes a first locking part which is associated with a first one of the assemblies and a housing part and two slots each having at least one first engagement protrusion, wherein at least one of the slots includes an adjustment element which can be adjusted relative to the housing part. The locking device also includes a second locking part which is associated with a second one of the assemblies and comprises two engagement elements each with at least one second engagement protrusion. The adjustment element is arranged on the housing part of the first locking part so as to be adjustable between a first position and a second position.

### CROSS-REFERENCE TO RELATED APPLICATIONS

This application is the United States national phase of International Patent Application No. PCT/EP2022/085410 filed Dec. 12, 2022, and claims priority to German Patent Application No. 10 2022 104 735.0 filed Feb. 28, 2022, the disclosures of which are hereby incorporated by reference in their entireties.

### BACKGROUND

### Technical Field

The solution relates to a locking device for connecting two assemblies to one another.

### Technical Considerations

A locking device of this type comprises a first locking part associated with a first one of the assemblies, which comprises a housing part and two slots, each with at least one first engagement protrusion. An adjustment element that can be adjusted relative to the housing part is arranged in at least one of the slots. The locking device also comprises a second locking part associated with a second one of the assemblies, which comprises two engagement elements each with at least one second engagement protrusion. To close the locking device, each of the engagement elements of the second locking part can be attached to one of the slots of the first locking part. In a closed position, the first engagement protrusions engage with the second engagement protrusions to hold the first locking part and the second locking part against each other in the opposite direction to the closing direction. To open the locking device, the first locking part and the second locking part can be separated from each other, wherein the first locking part and the second locking part can be moved relative to each other along a movement plane perpendicular to the closing direction (X) to open the locking device.

In the closed position, such a locking device is intended to create a reliable, firm, resilient hold between the locking parts in order to connect the assemblies associated with the locking parts to one another and to hold them together mechanically. The locking device should be easy to handle in that the locking device can be conveniently closed and also conveniently opened again.

A locking device of this type can, for example, be used on a vehicle, such as a motor vehicle or a bicycle, in order to connect assemblies together. For example, such a locking device can be used to attach an assembly to a bicycle frame.

In the locking device, it is desirable that locking parts are held together in the closed position in a vibration-proof and rattle-free manner, wherein it should be borne in mind that mechanical manufacturing tolerances may exist. In operation, a firm, essentially play-free connection between the locking parts should be created for an enhanced user experience.

In a locking device known from DE 10 2018 123 026 A1, locking parts are attached to locking elements arranged on a base body in order to close the locking device. Locking sections are arranged on the locking elements and the locking parts, which mechanically engage with each other in the closed position of the locking device and create a form-fit connection. The fastening device of DE 10 2018 123 026 A1, for example, implements a locking device for straps of a baby carriage or a child seat.

WO 2020/216955 A1 describes a locking device for connecting two assemblies to one another, which comprises a first locking part with a locking piece and a first magnetic element and a second locking part with a locking receptacle and a second magnetic element. In addition, the locking device comprises a locking mechanism arranged on the second locking part, which comprises a locking element and an actuating mechanism operatively connected to the locking element, wherein the locking element can be brought into operative connection with the locking piece in a closed position in order to lock a positive engagement between locking sections of the first locking part and the second locking part.

WO 2010/084191 A1 describes a locking device in which a connecting module with a locking piece can be attached to a spring locking element of a further connecting module. The spring locking element is rotatably arranged on the further connection module in such a way that opening of the locking device can be blocked by rotating the spring locking element.

### SUMMARY

Accordingly, provided is an improved locking device which is easy to handle and which, in a closed position, enables the locking parts to be held together in a reliable, robust manner.

Accordingly, the adjustment element is arranged on the housing part of the first locking part so as to be adjustable between a first position and a second position, wherein the adjustment element is configured such that, in the first position, the first locking part and the second locking part can be attached to one another along a closing direction in order to close the locking device, and, in the second position, to block movement of the first locking part and the second locking part along the movement plane relative to one another, thereby preventing the locking device from opening.

The locking device comprises two locking parts that can be attached to one other along the closing direction to close the locking device. The locking device can be configured as a purely mechanical locking device, in which the locking parts are held together mechanically in the closed position by mechanical engagement of the locking parts. However, the locking device can also be configured as a mechanical-magnetic locking device, in which the locking parts are magnetically drawn towards each other along the closing direction for closing and are preferably held together both mechanically and magnetically in the closed position.

The first locking part comprises a housing part and two slots formed thereon, each with at least one first engagement protrusion. An adjustment element arranged adjustably on the housing part is provided on at least one of the slots, preferably on both slots. In contrast, the second locking part comprises two engagement elements, each with at least one second engagement protrusion. In the closed position, the engagement protrusions engage with each other in such a way that the locking parts are held against one other in the opposite direction to the closing direction.

A locking device is thus provided with (at least) two slots on the first locking part, so that a connection between the locking parts is created by engagement of two engagement elements of the second locking part on slots of the first locking part.

In this case, the (each) adjustment element is arranged on the housing part of the first locking part so as to be adjustable between a first position and a second position. The adjustment element can, for example, be rotatably arranged on the housing part. In the second position, the adjustment element blocks movement of the first locking part and the second locking part, so that in the second position of the adjustment element, the locking parts cannot be moved relative to one another along the movement plane perpendicular to the closing direction. In the second position of the adjustment element, the locking device can therefore not be opened. To open the locking device, the (each) adjustment element must be moved to the first position so that the locking parts can be moved relative to one another along the movement plane. In the first position of the adjustment element, the locking parts can be moved relative to each other (in a plane perpendicular to the closing direction) in order to disengage the engagement protrusions from each other and thus release the connection between the locking parts.

If each of the slots comprises an adjustment element, in one non-limiting embodiment, the adjustment elements can be adjusted jointly and preferably synchronously at the slots of the first locking part via an actuating mechanism of the first locking part. The actuating mechanism may comprise a drive element, for example in the form of a gear wheel. When the drive element is actuated, the adjustment elements are adjusted together.

In another non-limiting embodiment, the adjustment elements can also be adjustable independently of one another, for example by allowing a user to act independently on each adjustment element in order to adjust the respective adjustment element without the other adjustment element also being adjusted.

In one non-limiting embodiment, one of the locking parts comprises a bearing pin and the other of the locking parts comprises an engagement opening. In the closed position, the bearing pin engages in the engagement opening and thereby supports the first locking part and the second locking part against one other. The engagement of the bearing pin with the engagement opening can provide support for the locking parts in a plane perpendicular to the closing direction. The engagement can also be used to create a rotational mounting of the locking parts against each other, so that the engagement of the bearing pin in the engagement opening means that the locking parts are mounted so that they can pivot relative to each other about the closing direction. To open the locking device, the locking parts can, for example, be pivoted relative to one another about the pivot bearing provided by the bearing pin and the engagement opening in order to thereby disengage the at least one first engagement protrusion of the first locking part and the at least one second engagement protrusion of the second locking part from one another and thus release the connection between the locking parts.

The adjustment element can be moved from the first position to the second position manually by a user, for example. When the locking device is closed, the adjustment element on the first locking part is preferably in the first position. Once the locking parts have been attached to one other, the user transfers the (each) adjustment element from the first position to the second position in order to lock the locking parts against each other. This results in a two-stage locking process in which the user first attaches the locking parts to one other and, after attachment, adjusts the adjustment element on the first locking part to complete the connection between the locking parts.

However, the adjustment element can also be moved from the first position to the second position automatically, for example by the adjustment element being spring-loaded on the housing part of the first locking part in the direction of the second position and the adjustment element being released when the locking parts are attached to one other so that the adjustment element moves automatically from the first position to the second position. To open the locking device, in one non-limiting embodiment, the first engagement protrusions and the second engagement protrusions can be disengaged from one another by pivoting the first locking part and the second locking part along the movement plane relative to one another.

In another non-limiting embodiment, the first engagement protrusions and the second engagement protrusions for opening the locking device can be disengaged from one another by parallel displacement of the first locking part and the second locking part along the movement plane relative to one another.

In one non-limiting embodiment, the at least one first engagement protrusion of the at least one of the slots is arranged on the adjustment element and can be adjusted together with the respective adjustment element relative to the housing part. The connection between the locking parts is thus established by engagement of the engagement protrusion on the adjustment element of the first locking part on the one hand and on the associated engagement element of the second locking part on the other. When the adjustment element is moved on the housing part of the first locking part, the first engagement protrusion is moved together with the adjustment element, wherein a pretensioning force can also be introduced into the engagement element of the second locking part via the engagement of the engagement protrusions, for example.

In another non-limiting embodiment, however, it is also possible that for one or both of the slots the at least one first engagement protrusion is formed on the housing part and is thus not arranged on the adjustment element. By adjusting the respective adjustment element, it is possible, for example, to bring the respective engagement element of the second locking part with the at least one second engagement protrusion arranged thereon into engagement with the first engagement protrusion on the housing part of the first locking part or at least to hold it (secure it). If the engagement protrusions have already come into engagement, for example through magnetic interaction, without the intervention of the adjustment element, the adjustment element with the collar portion can lock the engagement element at least in such a way that the engagement of the engagement protrusions is ensured.

In one non-limiting embodiment, the (each) adjustment element comprises a base and a collar portion rigidly formed on the base and projecting from the base along the closing direction. The base forms a body of the adjustment element and can, for example, provide a surface extending substantially perpendicular to the closing direction, which provides, for example, a contact surface for the engagement element of the second locking part in the closed position. The collar portion projects from the base along the closing direction and can, for example, provide a circumferentially closed or also circumferentially open wall on the base in the manner of a C-ring, within which the engagement element of the second locking part is accommodated in the closed position.

The collar portion can be used to create a receptacle for the associated engagement element. In the second position of the adjustment element, the collar portion can be used, for example, to block opening of the locking device by a relative movement of the locking parts in a plane perpendicular to the closing direction, so that opening of the locking device is prevented by the adjustment element in the second position and the locking device can only be opened when the adjustment element on the first locking part has been moved back into the first position.

The engagement elements of the second locking part are, for example, each formed by a rigid pin. The at least one second engagement protrusion projects radially from the pin in order to establish a connection between the locking parts in the closed position by engaging with the at least one first engagement protrusion of the first locking part.

In one non-limiting embodiment, the at least one first engagement protrusion is arranged on the collar portion for the (each) adjustment element. The engagement protrusion is preferably rigidly formed on the collar portion. The collar portion is also rigidly formed and connected to the rigid base, so that the adjustment element as a whole is formed as an essentially rigid part that is not elastically deformable under the intended load.

In one non-limiting embodiment, the at least one first engagement protrusion projects from the collar portion transversely to the closing direction and preferably projects radially inwards in order to establish a connection between the locking parts in the closed position via the engagement with the at least one second engagement protrusion of the engagement element of the second locking part.

The at least one first engagement protrusion and the at least one second engagement protrusion of each engagement element preferably each form an undercut. The undercut is not necessarily formed by surfaces perpendicular to the closing direction. Rather, surfaces of the undercut may also extend at an angle to the closing direction. The undercut of the respective engagement protrusion is formed by the engagement protrusion projecting transversely to the closing direction and by engagement of the engagement protrusions with one another, a movement of the locking parts along the closing direction is blocked, so that the locking parts are held together along the closing direction in the closed position of the locking device-possibly with the additional blocking effect of a blocking element.

For each pair of adjustment element and associated engagement element, the at least one first engagement protrusion and the at least one second engagement protrusion are preferably positively engaged with one another in the closed position. The locking parts are thus held together due to the shape of the engagement protrusions. The form-fit connection can be established solely via the engagement protrusions. In another non-limiting embodiment, however, the form-fit connection can also be achieved by engagement of the engagement protrusions and an additional locking effect, for example via the adjustment element, in such a way that the engagement protrusions can slide away from each other along the closing direction after the locking effect is removed.

In one non-limiting embodiment, the first locking part and the second locking part can only be attached to each other in the first position of the adjustment element in order to close the locking device. The adjustment element must therefore be brought into the first position on the first locking part in order to enable the locking parts to be attached to one another. By moving the adjustment element on the first locking part from the first position to the second position, the connection between the locking parts is then completed by blocking the opening of the locking device via the adjustment element in the second position.

In another non-limiting embodiment, however, it may also be possible to position the locking parts in the second position of the adjustment element. In this case, the adjustment element can, for example, be configured elastically in its entirety or with a section in order to deflect transversely to the closing direction when the locking parts are positioned against each other and thus enable the locking parts to be positioned against each other.

In one non-limiting embodiment, the adjustment element is rotatable between the first position and the second position relative to the housing part of the first locking part. In particular, the adjustment element can be rotatable relative to the housing part about an axis of rotation which is directed along the (parallel to the) closing direction. In the first position, the (each) adjustment element is in a first rotational position on the housing part. In the second position, the adjustment element is rotated on the housing part in order to prevent the locking parts from moving relative to one another along the movement plane in the second position and thus to prevent the locking device from opening.

The adjustment element of at least one of the slots of the first locking part is adjustable on the housing part. In one non-limiting embodiment, the adjustment element of each slot serves to exert a pretensioning force along the closing direction on the respectively associated engagement element in a second position. In the first position of the adjustment element, the locking parts can be positioned against each other. Once the locking parts have been positioned against each other, the adjustment element can be adjusted on the first locking part in order to create a pretensioning force between the locking parts, which acts along the closing direction and thus pretensions the locking parts towards each other along the closing direction.

By providing a pretensioning force, the locking parts can be held together in the closed position with essentially no play or rattling. Thus, by pretensioning the locking parts towards each other in the second position along the closing direction via the adjustment element(s), an axial play along the closing direction, which is caused for example by manufacturing tolerances, can be compensated for and the locking parts are held together firmly and essentially free of play along the closing direction. During operation of the locking device, the hold of the locking parts on each other can be improved in this way, wherein in particular a susceptibility to vibration can be suppressed.

In one non-limiting embodiment, the (each) adjustment element is axially adjustable on the housing part. In the first position, the adjustment element is in a first axial position relative to the housing part and, in the second position, a second axial position relative to the housing part that differs from the first axial position and is offset along the closing direction. By adjusting the adjustment element on the housing part, the adjustment element is thus adjusted axially along the closing direction on the housing part in order to create a prestress between the locking parts. By axially adjusting the adjustment element, the adjustment element can, for example, cause a tensile effect or a compressive effect on the associated engagement element of the second locking part along the closing direction in order to provide a prestress between the locking parts in this way.

For example, the adjustment element may cause a tensile effect in the closing direction on the engagement element. If at least one first engagement protrusion formed on the adjustment element is in engagement with the at least one second engagement protrusion on the engagement element, a tensile effect can be produced on the engagement element when the adjustment element on the housing part of the first locking part is axially displaced in the closing direction, so that the engagement element is (further) pulled in the closing direction into engagement with an associated insertion opening on the housing part of the first locking part.

Alternatively, a prestress can also be applied to the engagement element against the closing direction. For example, the adjustment element may apply pressure to the engagement element against the closing direction. For this purpose, the base of the engagement element can press on the engagement element, for example. If the engagement element is adjusted axially against the closing direction on the housing part of the first locking part when it is moved from the first position to the second position, the base of the engagement element presses on the engagement element and thus preloads it against the closing direction relative to the housing part.

In one non-limiting embodiment, the first locking part comprises a run-on element with a first frame section arranged on the housing part at the at least one of the slots and the adjustment element comprises a run-on section with a second frame section. The first frame section slides on the second frame section when the respective adjustment element is adjusted for axial adjustment of the adjustment element. If the adjustment element on the housing part of the first locking part is adjusted, for example rotated, the adjustment element thus runs with its run-on section onto the run-on element on the housing part, so that an axial adjustment of the adjustment element on the housing part is effected as a result, in order in this way to effect an axial pretension between the locking parts when transferring to the second position.

The run-on element is preferably co-rotationally connected to the housing part. The run-on element can be formed in one piece on the housing part or attached to the housing part as a separate element, wherein the run-on element is not moved in the direction of adjustment when the adjustment element is adjusted relative to the housing part, but remains fixed to the housing part in terms of rotation.

In one non-limiting embodiment, the first locking part and/or the second locking part comprise at least one resilient element that is elastically deformable along the closing direction. For example, an resilient element that is elastically deformable along the closing direction can be arranged at each slot of the first locking part, via which the associated run-on element is supported along the closing direction relative to the housing part. The resilient element is elastically tensioned when the associated adjustment element is moved, so that an elastic pretensioning force is created between the locking parts. By transferring to the second position, the adjustment element can load the respectively associated engagement element of the second locking part, for example in the closing direction in the direction of engagement with a slot on the first locking part, wherein the resilient element is elastically deformed and thus tensioned, thereby providing an elastic pretensioning force between the locking parts.

The resilient element can, for example, be formed by an element molded from an elastomeric material, for example in the form of an O-ring. In another non-limiting embodiment, the resilient element can, for example, be formed by a mechanical spring element, for example made from a spring steel or a plastic material, for example as a disk spring.

The resilient element can be configured as a separate element or can be formed in one piece with the run-on element or the housing part or even with a housing of the second locking part.

In one non-limiting embodiment, the first locking part comprises an actuating element that can be actuated in order to move the adjustment element between the first position and the second position. The actuating element can, for example, be moved linearly along the actuating direction to the housing part and is thus configured in the manner of a slider or lever handle, which can be adjusted linearly by a user. The actuating element can be used to move the adjustment element on the housing part by a user manually actuating the actuating element and thereby moving the adjustment element from the first position to the second position after the locking parts have been attached to one another or, conversely, moving the adjustment element from the second position to the first position to release the locking device.

In one non-limiting embodiment, the first locking part comprises a drive element which is operatively connected to the adjustment element and which is configured to introduce an adjusting force into the adjustment element when actuated. The drive element can be provided in addition to the actuating element. However, the drive element can also be provided without an additional actuating element and can be actuated by a user, for example manually, in that a user can act on the drive element in order to thereby introduce an adjusting force into the adjustment element, in particular in order to transfer the adjustment element from the first position to the second position or, conversely, from the second position to the first position.

The drive element can, for example, be arranged rotatably on the housing part of the first locking part. The drive element can, for example, be configured in the form of a toothed wheel that engages with the adjustment element so that a rotary movement of the drive element is introduced into the adjustment element, thereby moving the adjustment element between the first position and the second position.

In one non-limiting embodiment, the drive element comprises a first toothed portion that is in toothed engagement with a toothed portion of the actuating element. In this case, an additional actuating element is thus provided that can be actuated in order to adjust the drive element. The actuating element is in toothed engagement with the drive element so that the drive element is rotated on the housing part during a (linear) movement of the actuating element.

In one non-limiting embodiment, the drive element comprises—in addition or as an alternative to the first toothed portion-a second toothed portion which is in toothed engagement with a toothed portion of the adjustment element. An adjusting force is thus introduced into the adjustment element via the toothing engagement of the second toothed portion with the toothed portion of the adjustment element, so that the adjustment element is adjusted on the housing part during a (rotational) movement of the drive element.

A status indicator can be arranged on the actuating element and/or on the drive element, which indicates to a user in which position the adjustment element is located. Using the status indicator, a user can thus immediately recognize whether the adjustment element has been moved from the first position to the second position for closing the locking device and whether the closing of the locking device has thus been completed. The status indicator can be provided, for example, by a colored or other marking on the actuating element or the drive element.

For example, a colored (e.g. red) marking can be displayed to a user in a position of the actuating element that is associated with the first position of the adjustment element. After the actuating element has been actuated to move the adjustment element to the second position, the marking is no longer visible, so that a user can immediately recognize that the closing of the locking device has taken place correctly and is complete.

In one non-limiting embodiment, the housing part comprises an insertion opening at each slot, into each of which one of the engagement elements of the second locking part can be inserted along the closing direction to close the locking device. The insertion opening defines a slot for receiving the respective engagement element of the second locking part. When the locking parts are attached to one another, the engagement elements of the second locking part engage with the insertion openings on the housing part of the first locking part, wherein the engagement protrusions engage with each other and a connection is thus established between the locking parts.

The locking device is generally closed by attaching or placing the locking parts to one another along the closing direction, although it may also be possible to position the locking parts in a direction that deviates from the closing direction, for example along a direction that extends at an angle to the closing direction. In the case of a magnetically configured locking device, a magnetic attraction force acts between the locking parts essentially along the closing direction, so that the locking parts are pulled towards each other along the closing direction.

In one non-limiting embodiment, each insertion opening is opened through an exit opening in an opening direction transverse to the closing direction. In the first position of the adjustment element, the engagement elements can be moved out of the insertion openings in the opening direction to open the locking device. In the second position, on the other hand, the adjustment element, in one non-limiting embodiment, blocks the exit opening of the associated slot in such a way that the associated engagement element cannot be moved out of the insertion opening in the opening direction for opening the locking device.

The locking device is opened by relative movement of the locking parts in a plane perpendicular to the closing direction, for example by moving or rotating the locking parts relative to each other. The adjustment element is used, for example, to block the exit opening of the associated slot when the adjustment element is in the second position on the housing part of the first locking part, so that the locking device cannot be opened when the adjustment element is in the second position. Only when a user moves the (each) adjustment element from the second position to the first position can the connection between the locking parts be released by moving the engagement elements of the second locking part out of the insertion openings of the first locking part in the opening direction transverse to the closing direction.

In one non-limiting embodiment, the exit openings can open the insertion openings in different directions, in particular in opposite directions, so that one of the engagement elements can be removed from the associated insertion opening in a first direction and the other of the engagement elements can be removed from the other insertion opening in an opposite, second direction in order to open the locking device. By orienting the exit openings in this way, it is possible to open the locking device, for example by rotating the locking parts relative to one another about a central axis of rotation.

Alternatively, the exit openings can also open the insertion openings in the same direction, so that the engagement elements can be pushed out of the associated insertion openings parallel to each other in a common opening direction. In this case, the locking parts are thus moved parallel to each other (and not rotated relative to each other) to open the locking device.

The locking device can be configured as a purely mechanical locking device. However, the locking device can also be configured as a mechanical-magnetic locking device with magnetic elements.

In one non-limiting embodiment, the first locking part comprises a first magnetic element and the second locking part comprises a second magnetic element, wherein the first magnetic element and the second magnetic element interact in a magnetically attracting manner in order to magnetically support the application of the first locking part and the second locking part for closing the locking device along the closing direction. The magnetic elements have a magnetically attractive effect along the closing direction and thus pull the locking parts towards each other along the closing direction when they are applied, so that the closing of the locking device is magnetically supported.

The magnetic elements of the locking parts can each be formed by a permanent magnet. Alternatively, one of the magnetic elements can be formed by a permanent magnet and the other of the magnetic elements by a ferromagnetic armature.

Magnetic elements of the first locking part can be arranged on the housing part or on the adjustment elements of the slots. Magnetic elements of the second locking part can, for example, be arranged on the engagement elements of the second locking part.

In one non-limiting embodiment, the first locking part comprises a first electrical contact arrangement and the second locking part has a second electrical contact arrangement. In the closed position, the first electrical contact arrangement and the second electrical contact arrangement are in operative contact with one another, so that an electrical connection is established between the contact arrangements when the locking device is in its closed position.

Each contact arrangement can comprise one, two or more electrical contacts, for example three contacts, four contacts or seven contacts or even a different number of contacts. The locking device thus acts as an electrical locking device via which an electrical connection is established between the associated assemblies in the closed position.

The locking device can be used to connect two assemblies of a vehicle, for example a motor vehicle or a bicycle, for example an electric bicycle (e-bike).

In one non-limiting embodiment, the locking device can be configured to connect an electrical assembly to an electric bicycle (e-bike). For example, a battery assembly, for example in the form of a so-called range extender, can be connected to a bicycle frame of a bicycle via the locking device.

In one non-limiting embodiment, a bicycle comprises a locking device of the type described above, wherein the locking device is configured to connect an assembly to a bicycle frame. The assembly can, for example, be a battery assembly.

Other applications are also conceivable. For example, when using the locking device on a bicycle, any assembly, for example a lock assembly, a container, a drinking bottle or a piece of luggage can be connected to a bicycle frame, a bicycle handlebar or a bicycle luggage carrier via the locking device.

### BRIEF DESCRIPTION OF THE DRAWINGS

The idea underlying the solution will be explained in more detail below with reference to the non-limiting embodiments shown in the figures.

FIG. 1 is a perspective exploded view of a non-limiting embodiment of a locking device with a first locking part and a second locking part that can be connected to the first locking part along a closing direction.

FIG. 2 is another exploded view of the locking device;

FIG. 3A is a perspective view of the locking device before closing;

FIG. 3B is a front view of the arrangement shown in FIG. 3A;

FIG. 3C is a top view of the arrangement according to FIG. 3A;

FIG. 3D is a sectional view along line A-A as shown in FIG. 3C;

FIG. 3E is a side view of the arrangement according to FIG. 3A;

FIG. 3F is a sectional view along line B-B as shown in FIG. 3E;

FIG. 3G is a top view of the first locking part of the locking device in the position shown in FIG. 3A;

FIG. 3H is a view of the first locking part from below;

FIG. 4A is a perspective view of the locking device during closing;

FIG. 4B is a front view of the arrangement shown in FIG. 4A;

FIG. 4C is a top view of the arrangement according to FIG. 4A;

FIG. 4D is a side view of the arrangement according to FIG. 4A;

FIG. 4E is a sectional view along line A-A as shown in FIG. 4D;

FIG. 4F is a sectional view along line B-B as shown in FIG. 4D;

FIG. 5A is a perspective view of the locking device, during further closing;

FIG. 5B is a front view of the arrangement shown in FIG. 5A;

FIG. 5C is a top view of the arrangement according to FIG. 5A;

FIG. 5D is a side view of the arrangement according to FIG. 5A;

FIG. 5E is a sectional view along line A-A as shown in FIG. 4D;

FIG. 6A is a perspective view of the locking device, upon actuation of adjustment elements of the first locking part;

FIG. 6B is a front view of the arrangement shown in FIG. 6A;

FIG. 6C is a top view of the arrangement according to FIG. 6A;

FIG. 6D is a side view of the arrangement according to FIG. 6A;

FIG. 6E is a top view of the first locking part of the locking device in the position shown in FIG. 6A;

FIG. 6F is a view of the first locking part from below;

FIG. 6G is a top view of the arrangement according to FIG. 6A;

FIG. 6H is a sectional view along line A-A as shown in FIG. 6G;

FIG. 7A is a perspective view of the locking device in a closed position after the actuating elements of the first locking part have been actuated;

FIG. 7B is a front view of the arrangement shown in FIG. 7A;

FIG. 7C is a top view of the arrangement shown in FIG. 7A;

FIG. 7D is a sectional view along line A-A as shown in FIG. 7C;

FIG. 7E is a top view of the first locking part;

FIG. 8A is a view of a run-on element of the first locking part;

FIG. 8B, 8C show perspective views of the run-on element;

FIG. 9A, 9B show side views of the run-on element;

FIG. 10 is a top view of the run-on element;

FIG. 11 is a view of the first locking part from below, with run-on elements arranged on it;

FIGS. 12A-12D show side views of an adjustment element on an associated run-on element, viewed from four different spatial directions, each offset by 90° to the other;

FIGS. 13A-13D show the views according to FIGS. 12A to 12D, upon a rotary movement of the adjustment element relative to the run-on element;

FIGS. 14A-14D show the views according to FIGS. 13A to 13D, upon further rotation of the adjustment element relative to the associated run-on element;

FIGS. 15A, 15B show perspective views of an exemplary and non-limiting embodiment with electrical contact arrangements arranged on a first locking part and a second locking part;

FIG. 15C is a top view of the housing part of the first locking part with an electrical contact arrangement arranged thereon;

FIG. 15D is a sectional view of line A-A as shown in FIG. 15C;

FIG. 16 is a view of another non-limiting embodiment of a contact arrangement of the first locking part;

FIG. 17 is a view of another non-limiting embodiment of a contact arrangement of the first locking part;

FIG. 18A is a view of a non-limiting embodiment of a locking device with a first locking part, which comprises insertion openings open to the same side, in a non-actuated position of an actuating element;

FIG. 18B is the arrangement according to FIG. 18A, in an actuated position of the actuating element; and

FIG. 19 is a view of an associated second locking part.

### DETAILED DESCRIPTION

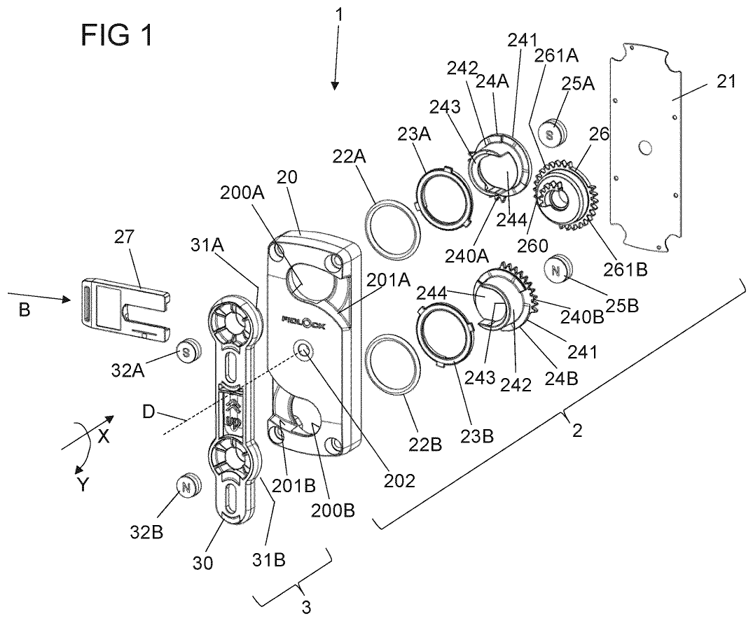

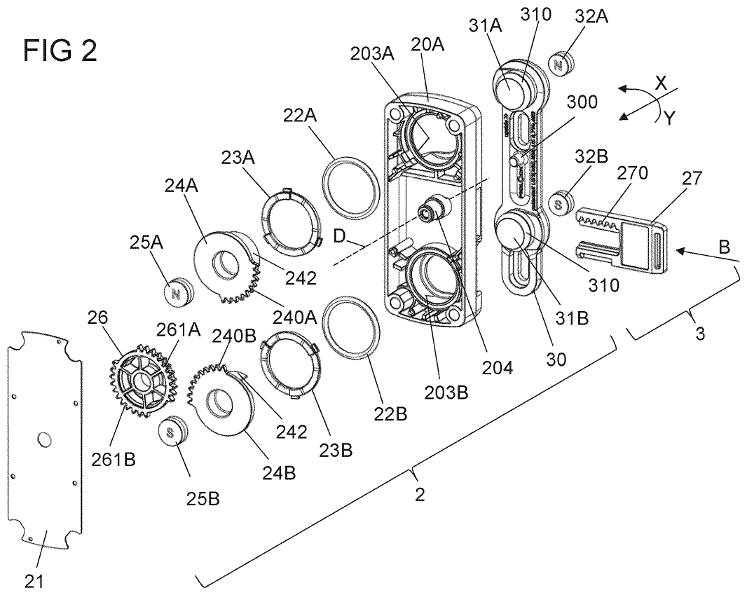

FIGS. 1 and 2 show an exemplary and non-limiting embodiment of a locking device 1 which comprises two locking parts 2, 3 which can be attached to one another along a closing direction X and are connected to one another in a closed position of the locking device 1 in such a way that the locking parts 2, 3 are fixed to one another along the closing direction X and in particular cannot be removed from one another in the direction opposite to the closing direction X without further action, at least not without releasing the connection.

A first locking part 2 comprises a housing part 20 which forms insertion openings 200A, 200B for inserting engagement elements 31A, 31B of a second locking part 3 formed on a housing 30. The engagement elements 31A, 31B can be inserted into the insertion openings 200A, 200B along the insertion direction X in order to connect the locking parts 2, 3 to one another in this way.

Within the housing part 20, adjustment elements 24A, 24B are each rotatably mounted in a bearing opening 203A, 203B. The adjustment elements 24A, 24B of the first locking part 2 are each formed by a base 244, from which a rigid collar portion 242 projects along the closing direction X. An engagement protrusion 243 is formed on the collar portion 242, which projects radially inwards from the (rigid) collar portion 242.

The collar portion 242 of each adjustment element 24A, 24B forms a receptacle for receiving an associated engagement element 31A, 31B of the second locking part 3 and has a C-shape which extends in a semicircle at the base 244. The base 244 forms a contact surface with which the respective associated engagement element 31A, 31B of the second locking part 3 can come into contact in a closed position of the locking device 1.

The adjustment elements 24A, 24B are each rotatably mounted in the associated bearing opening 203A, 203B of the housing part 20 and can thus be rotated relative to the housing part 20. As will be explained below, the adjustment elements 24A, 24B can be adjusted between a first position and a second position on the housing part 20. In the first position of the adjustment elements 24A, 24B, the second locking part 3 can be inserted with the engagement elements 31A, 31B into the insertion openings 200A, 200B, so that the locking parts 2, 3 can be connected to one another. In the second position, the adjustment elements 24A, 24B prevent the locking device 2, 3 from opening.

In the exemplary and non-limiting embodiment shown, a bearing pin 300 is formed on the housing 30 of the second locking part 3, which engages with an engagement opening 202 on the housing part 20 of the first locking part 2 when the locking parts 2, 3 are attached to one another. Via the engagement of the bearing pin 300 in the engagement opening 202, the locking parts 2, 3 are pivotably mounted relative to one another about an axis of rotation D when the locking parts 2, 3 are attached to one another.

The engagement elements 31A, 31B can each be inserted into the associated insertion openings 200A, 200B in the closing direction X. The insertion openings 200A, 200B are each opened laterally via an exit opening 201A, 201B in a movement plane perpendicular to the closing direction X, so that the engagement elements 31A, 31B can be moved out of the insertion openings 200A, 200B through the exit openings 201A, 201B by pivoting the locking parts 2, 3 relative to one another in an opening direction Y pointing around the closing direction X, in order to release the locking parts 2, 3 from one another in this way to open the locking device 1.

As can be seen, for example, in FIG. 2, the engagement elements 31A, 31B are formed as pins on the housing 30 of the second locking part 3. A circumferential engagement protrusion 310 is formed on a shaft portion 311, which in the closed position of the locking device 1 is in engagement with the engagement protrusion 243 of the associated adjustment element 24A, 24B of the first locking part 2, so that the locking parts 2, 3 are held together positively along the closing direction X via the engagement.

A drive element 26 is rotatably mounted on a bearing element 204 of the housing part 20 of the first locking part 2 (which forms the engagement opening 202 in its interior), which drive element 26 comprises toothed portions 261A, 261B which are in toothed engagement with toothed portions 240A, 240B of the adjustment elements 24A, 24B. By rotating the drive element 26, the adjustment elements 24A, 24B can thus be adjusted together and preferably synchronously on the housing part 20.

An actuating element 27 in the form of a pusher is arranged on the housing part 20 so as to be linearly displaceable along an actuating direction B. The actuating element 27 comprises a toothed portion 270 which is in toothed engagement with an associated toothed portion 260 of the drive element 26. A linear movement of the actuating element 27 is converted into a rotary movement of the drive element 26 via the toothed portion 270, which is configured in the manner of a toothed rack, so that the adjustment elements 24A, 24B on the housing part 20 can be adjusted via it.

The actuating element 27 can be actuated manually by a user. In particular, the adjustment elements 24A, 24B can be transferred from their first position, in which the locking parts 2, 3 can be placed against or attached to one another, into a second position, in which the connection of the locking parts 2, 3 to one another is blocked and the locking parts 2, 3 in particular cannot be pivoted relative to one another about the axis of rotation D for opening the locking device 1, by pressing the actuating element 27 in the actuating direction B into the housing part 20.

Run-on elements 23A, 23B are arranged on the housing part 20 in a non-rotatable manner and are supported axially along the closing direction X on the housing part 20 via resilient elements 22A, 22B in the form of elastically deformable ring elements. The run-on elements 23A, 23B are each in contact with an run-on section 241 on the respective associated adjustment element 24A, 24B, so that when the respective adjustment element 24A, 24B is rotated, the run-on section 241 of the adjustment element 24A, 24B slides on the run-on element 23A, 23B.

Ramp sections 232, 245 are formed on each run-on element 23A, 23B and the respective associated run-on section 241, which slide against each other when the adjustment element 24A, 24B is rotated and thus cause an axial change in position of the respective adjustment element 24A, 24B along the closing direction X relative to the housing part 20. In cooperation with the respective resilient element 22A, 22B, the adjustment elements 24A, 24B are adjusted in this way and cause an elastic preload on the engagement elements 31A, 31B, so that the locking parts 2, 3 are elastically preloaded in relation to each other and are thus fixed in place without play and rattle, while compensating for manufacturing and assembly tolerances.

The first locking part 2 comprises magnetic elements 25A, 25B, which are arranged on the adjustment elements 24A, 24B. On the second locking part 3, magnetic elements 32A, 32B are arranged on the engagement elements 31A, 31B. The magnetic elements 25A, 25B, 32A, 32B act together in a magnetically attractive manner and in this way support the positioning of the locking parts 2, 3 against each other along the closing direction X.

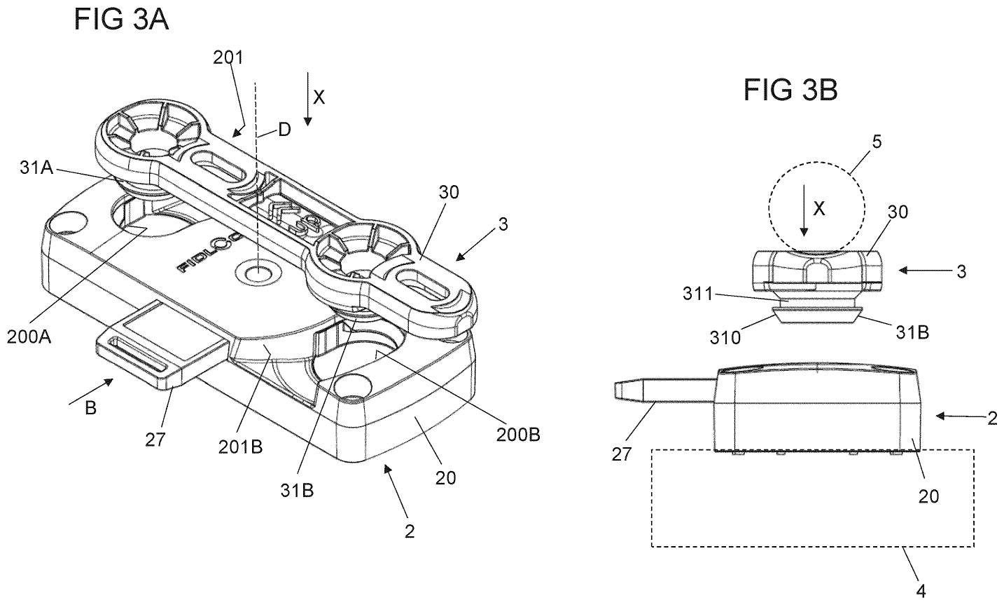

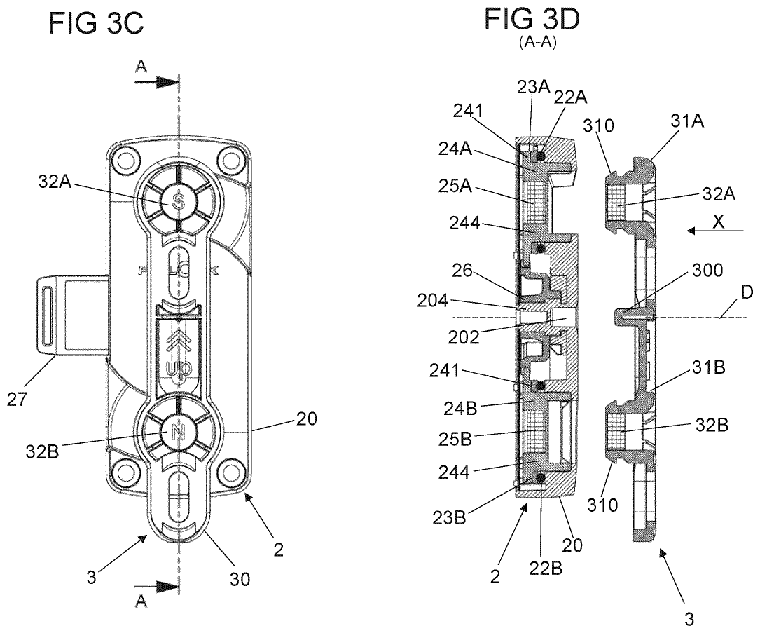

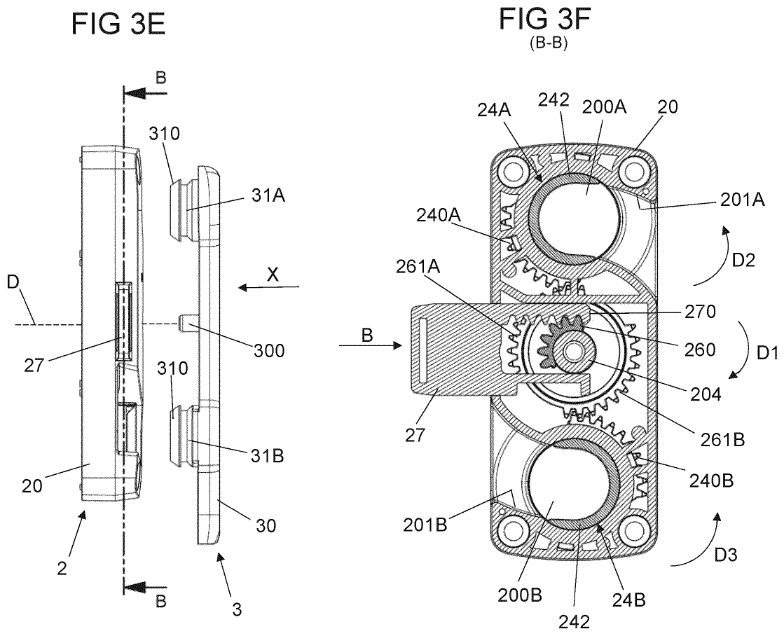

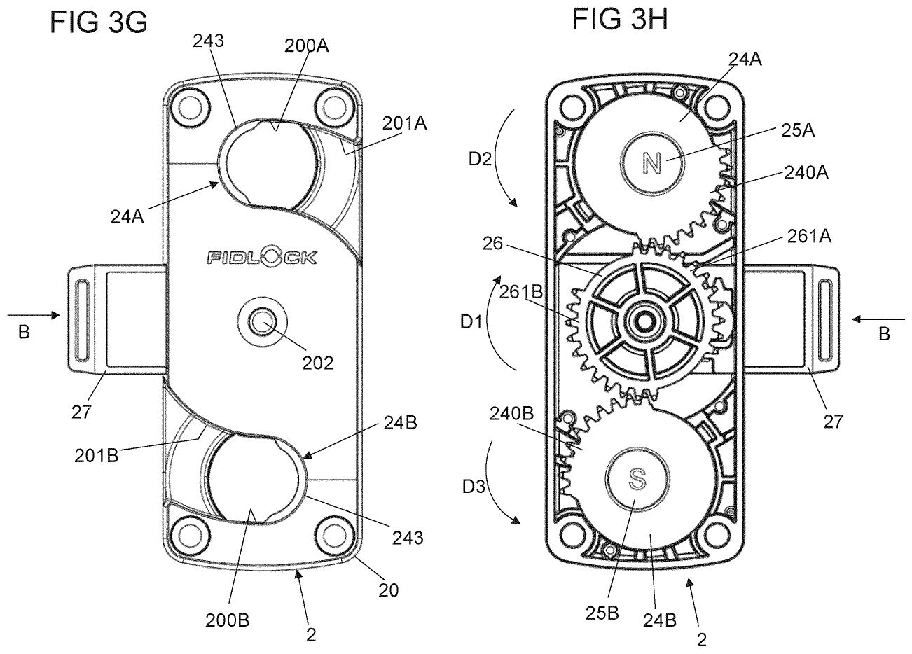

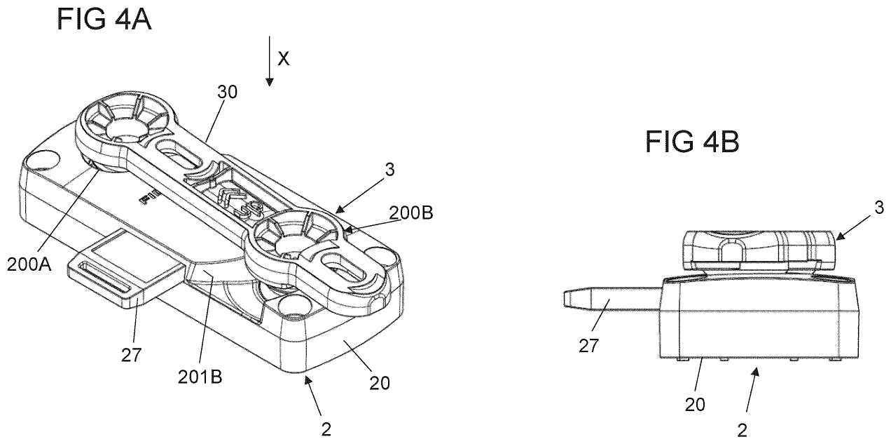

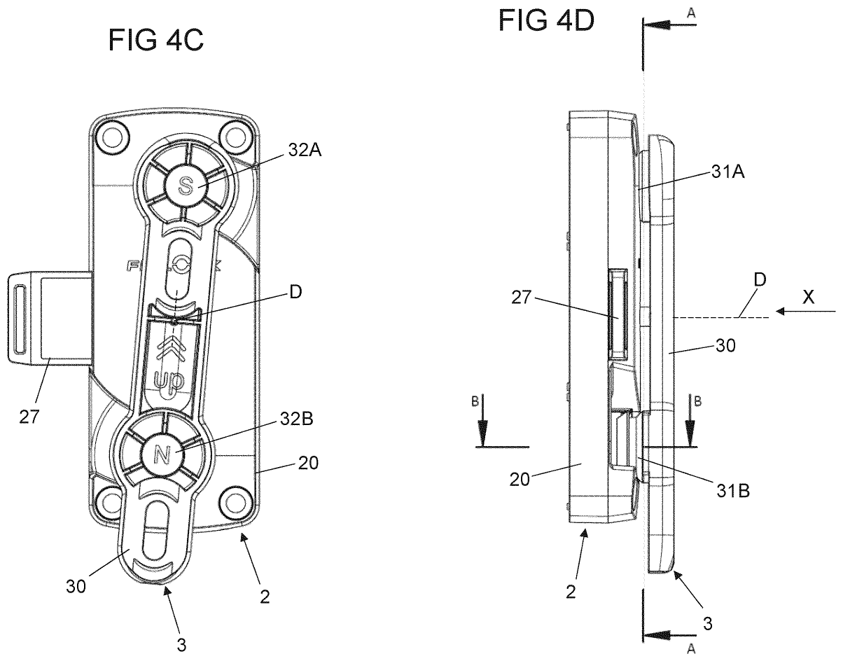

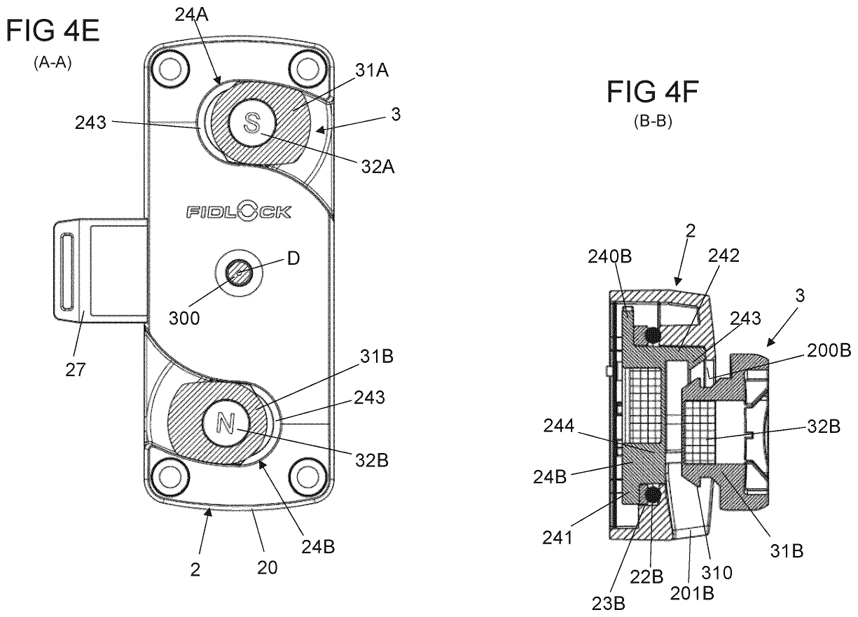

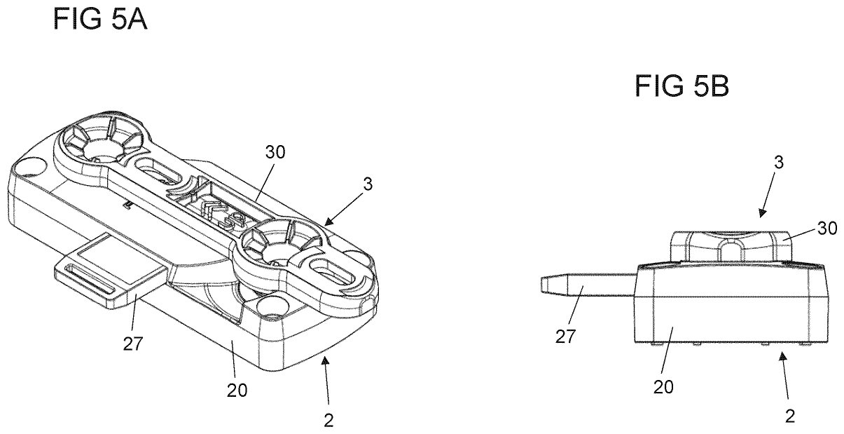

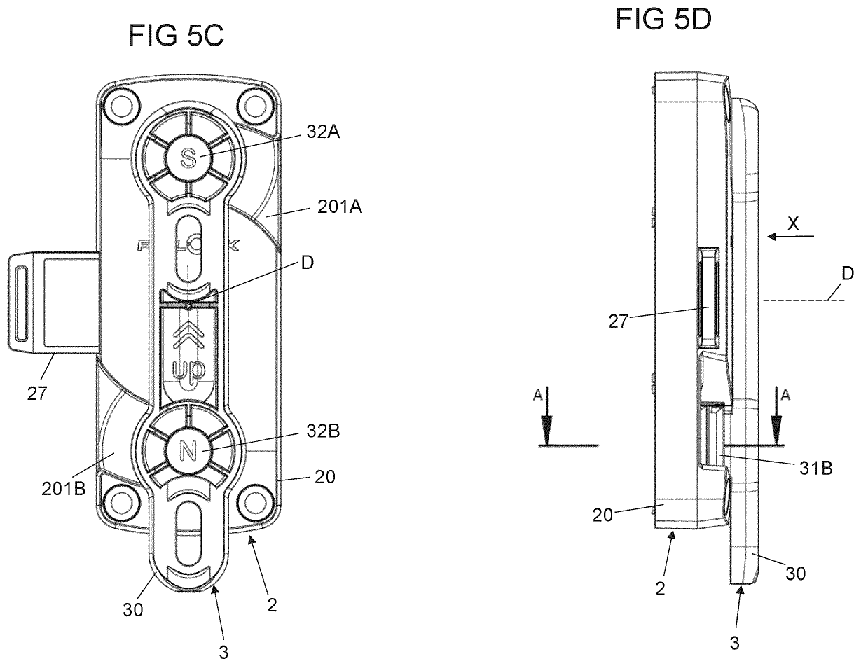

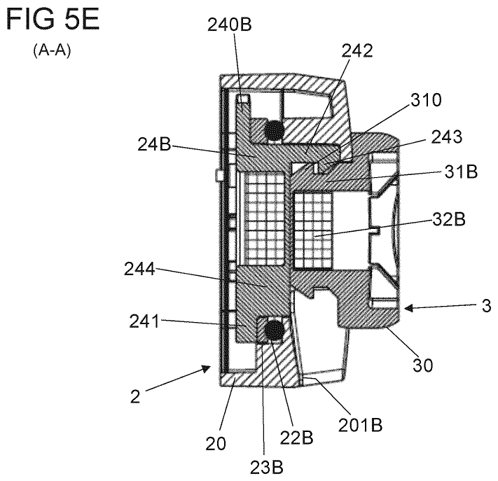

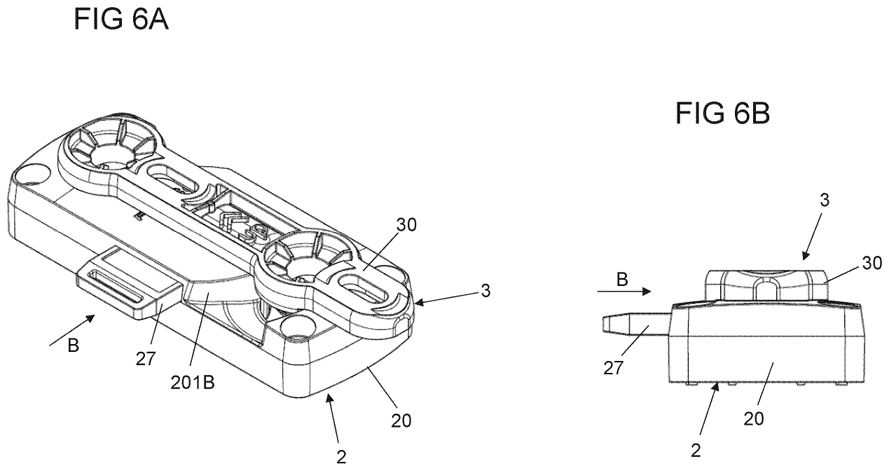

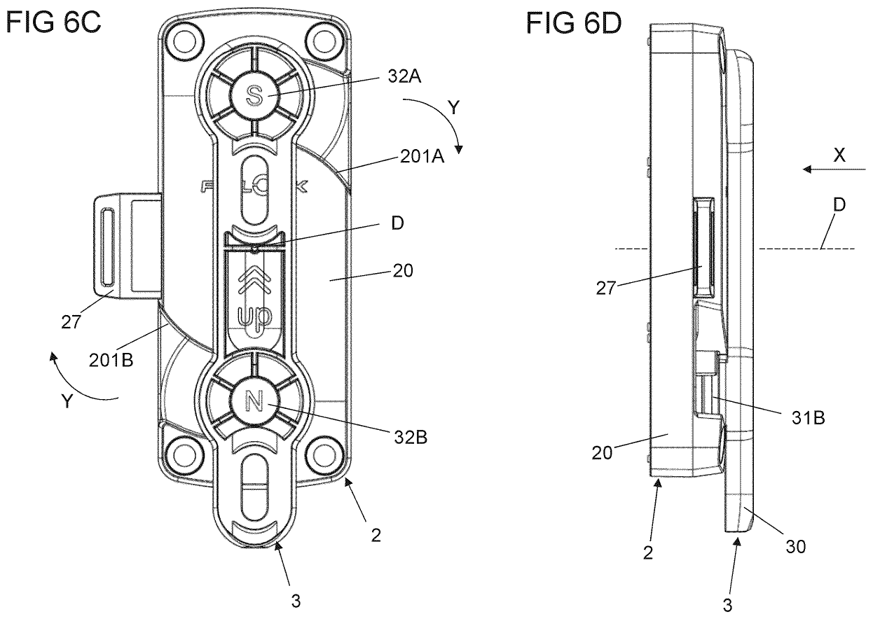

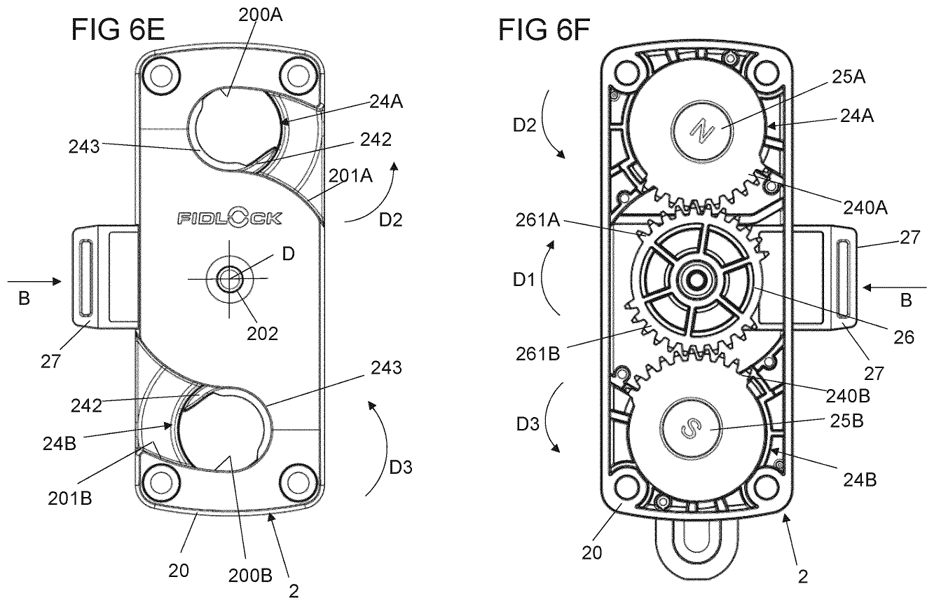

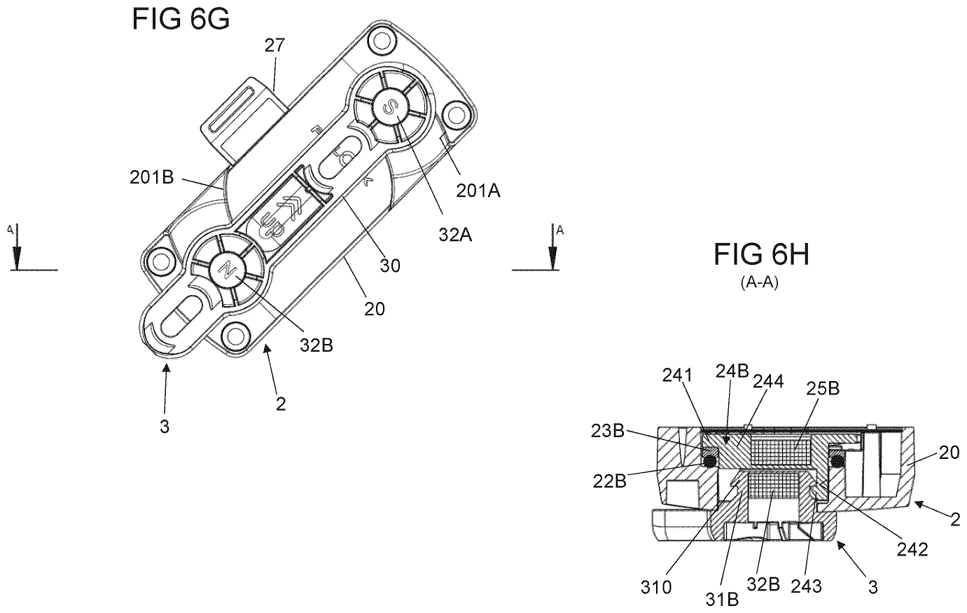

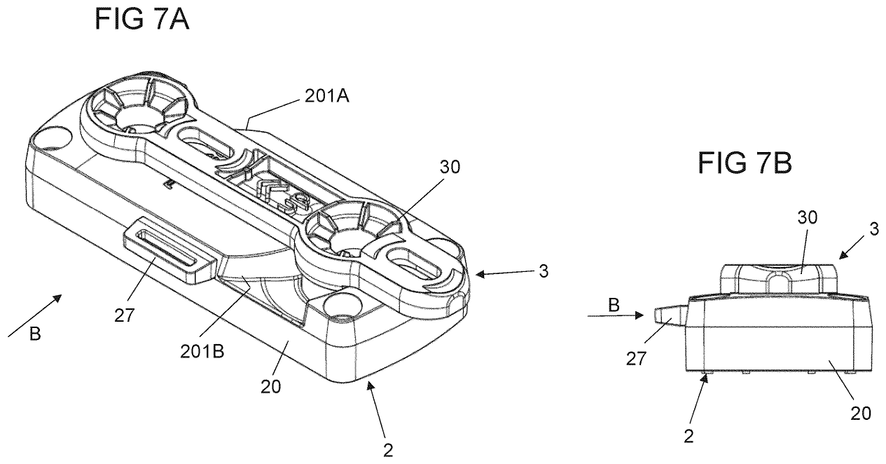

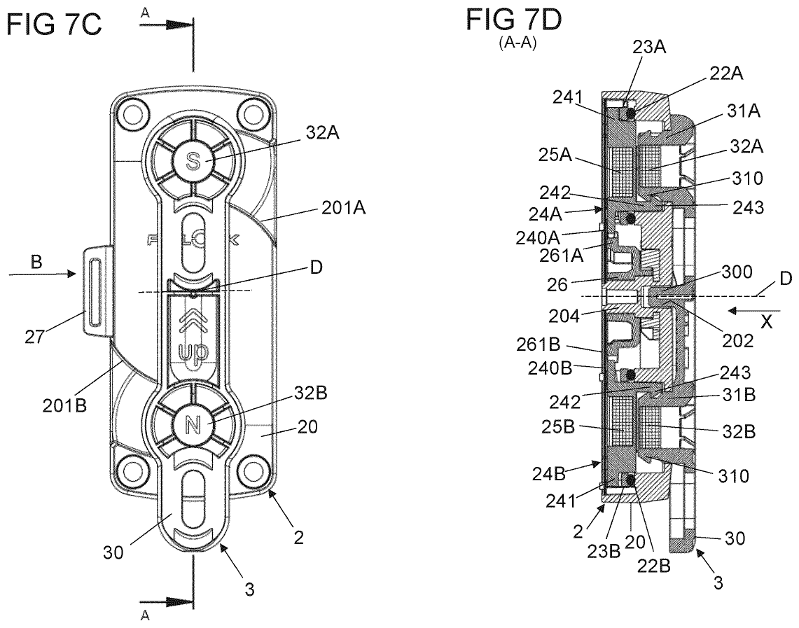

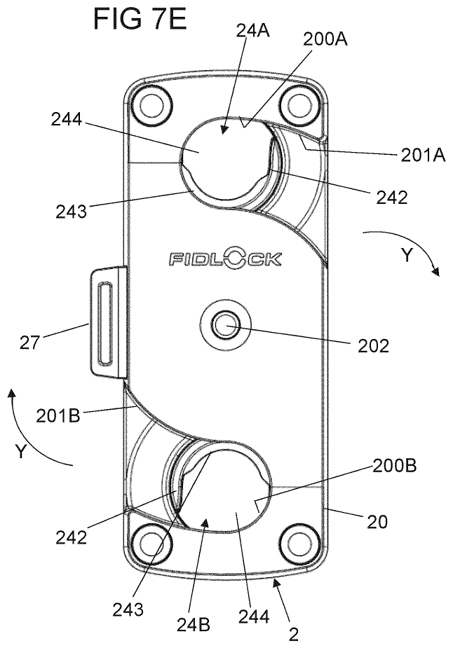

FIG. 3A-3H, FIG. 4A-4F, FIG. 5A-5E, FIG. 6A-6H and FIG. 7A-7E show the locking device 1 in different positions before closing (FIG. 3A-3H), during closing (FIG. 4A-4F, FIG. 5A-5E and FIG. 6A-6H) and in the closed position (FIG. 7A-7E).

To close the locking device 1, the locking parts 2, 3 are attached to each other along the closing direction X. As shown schematically in FIG. 3B, the locking parts 2, 3 are associated with different assemblies 4, 5, so that the assemblies 4, 5 can be connected to each other by connecting the locking parts 2, 3.

A relative movement between the locking parts 2, 3 is decisive for the connection, but it is not important whether one of the locking parts 2, 3 remains stationary during the closing process and only the other locking part 3, 2 is moved or whether both locking parts 2, 3 are moved towards each other.

For example, the locking part 3 can be fixed stationary to an associated assembly 5, for example a bicycle frame, so that the associated assembly 4 can be fixed to the assembly 5 by attaching the other locking part 2.

To close the locking device 1, the engagement elements 31A, 31B are inserted into the associated insertion openings 200A, 200B of the housing part 20 of the locking part 2 along the closing direction X, as can be seen from FIGS. 3A-3H. The adjustment elements 24A, 24B are here in the position shown in particular in FIG. 3A, in which the collar portion 242 assumes such a position in the respectively associated insertion opening 200A, 200B that the exit opening 201A, 201B is not blocked by the collar portion 242.

As can be seen from the sectional view according to FIG. 3D, the magnetic elements 25A, 25B, 32A, 32B of the locking parts 2, 3 are magnetically attracted to each other when the locking parts 2, 3 are attached to one another, so that the locking parts 2, 3 are drawn towards each other along the closing direction X.

As can be seen from FIG. 3A, the actuating element 27 assumes an outwardly projecting position on the housing part 20 in the position of the adjustment elements 24A, 24B shown. A marking, for example a red color marking, can be attached to the actuating element 27, for example, which signals to a user that the adjustment elements 24A, 24B are in their first position.

Upon attachment, the engagement protrusions 310 on the engagement elements 31A, 31B come into engagement with the engagement protrusions 243 on the rigid collar portions 242 of the adjustment elements 24A, 24B. When the locking parts 2, 3 are attached, the bearing pin 300 also comes into engagement with the associated engagement opening 202, so that a rotary bearing is produced between the locking parts 2, 3, as can be seen in FIGS. 4A-4F.

As can be seen from FIGS. 4A, 4C and 4F, the locking parts 2, 3 are deflected relative to one another about the axis of rotation D during attachment to such an extent that the engagement protrusions 310 on the engagement elements 31A, 31B can be moved past the engagement protrusions 243 on the adjustment elements 24A, 24B. After the engagement protrusions 310 on the engagement elements 31A, 31B have passed the engagement protrusions 243 on the adjustment elements 24A, 24B, the engagement protrusions 243, 310 come into engagement with one another transversely to the closing direction X, as can be seen in FIGS. 5A-5E.

After positioning the locking parts 2, 3, the adjustment elements 24A, 24B are initially still in their first position, as can be seen from FIGS. 5A-5E, in which the exit openings 201A, 201B at the insertion openings 200A, 200B are released and thus opening of the locking device 1 is possible by pivoting the locking parts 2, 3 about the axis of rotation D relative to one another. After positioning the locking parts 2, 3 against each other, a user can rotate the adjustment elements 24A, 24B from their first position into the second position by pressing the actuating element 27 in the actuating direction B into the housing part 20, as can be seen in the transition from FIGS. 6A-6H to FIGS. 7A-7E.

When the actuating element 27 is pressed in, the adjustment elements 24A, 24B are each rotated at the associated bearing openings 203A, 203B, so that the engagement protrusions 243 rotate at the insertion openings 200A, 200B (see FIGS. 6B and 6F). In the second position of the adjustment elements 24A, 24B, the collar portions 242 of the adjustment elements 24A, 24B each assume such a position at the associated insertion opening 200A, 200B that the collar portion 242 blocks the respectively associated exit opening 201A, 201B and thus the engagement elements 31A, 31B cannot be moved out of the insertion openings 200A, 200B in the opening direction Y.

In the second position of the adjustment elements 24A, 24B, pivoting of the locking parts 2, 3 about the rotary bearing created by the bearing pin 300 is thus blocked. The locking device 1 cannot be opened, at least not unintentionally without actuating the adjustment elements 24A, 24B.

As can be seen from FIG. 7E, in the second position of the adjustment elements 24A, 24B, the actuating element 27 is pressed into the housing part 20 so that, for example, a marking on the actuating element 27 is no longer visible. A user is thus informed that the adjustment elements 24A, 24B are in the second position and that the connection between the locking parts 2, 3 is thus secured.

If the locking device 1 is to be opened again, the actuating element 27 can be pulled out of the housing part 20 against the actuating direction B, so that the adjustment elements 24A, 24B are rotated from the second position (FIG. 7E) back into their first position (FIG. 3G). The locking parts 2, 3 can thus be pivoted towards each other about the axis of rotation D and the locking device 1 can be opened.

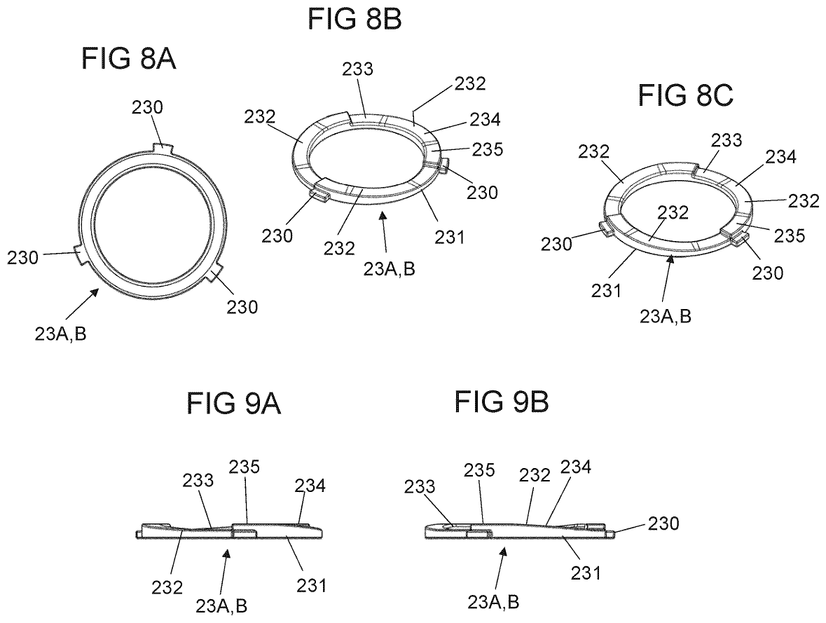

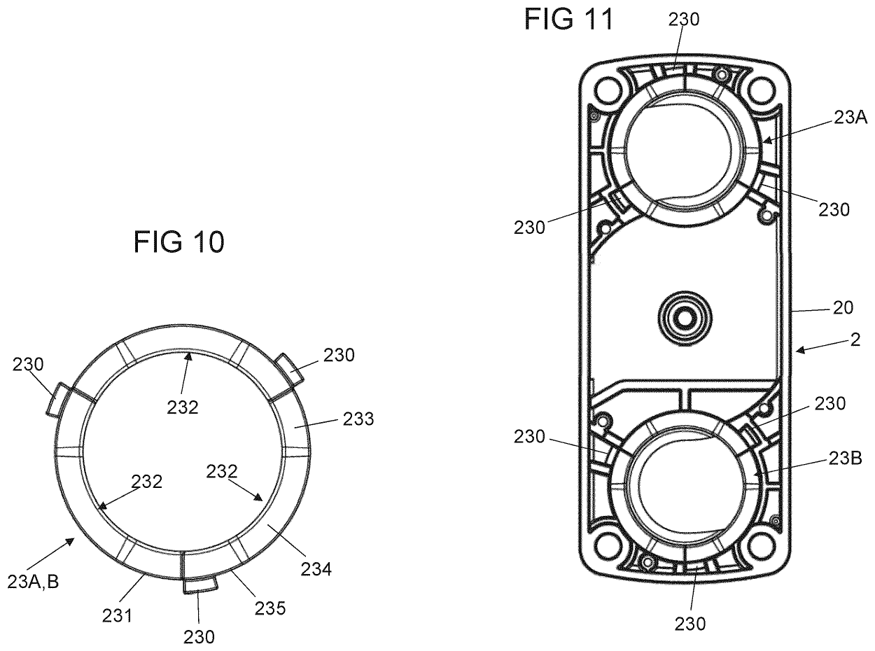

FIGS. 8A-8C, 9A, 9B and 10 show views of the run-on element 23A, 23B. One such run-on element 23A, 23B is associated with each adjustment element 24A, 24B.

The run-on element 23A, 23B is held non-rotatably on the housing part 20 via form-fit elements 230 in the form of radially projecting pins, as can be seen in FIG. 11. The run-on element 23A, 23B is supported axially on the housing part 20 via an resilient element 22A, 22B and can thus be moved at least slightly axially on the housing part 20 within the scope of the elasticity of the resilient element 22A, 22B.

The run-on element 23A, 23B comprises an annular body 231, on one side of which an run-on section 232 is formed. The run-on section 232 is formed by three ramp sections 234, each of which is adjoined on both sides by a plateau 233, 235. The plateaus 233, 235 are located axially at different positions.

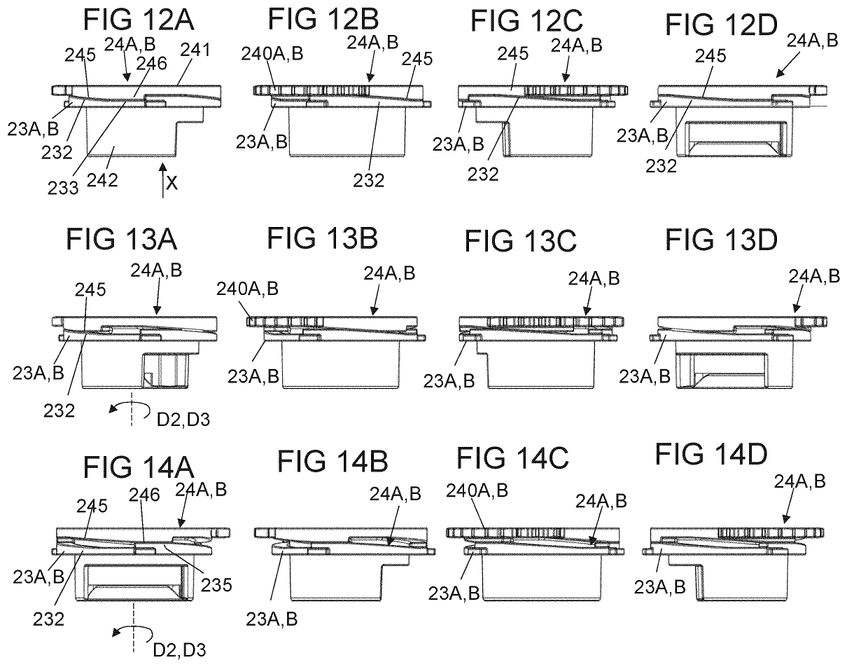

FIGS. 12A-12D show the adjustment elements 24A, 24B together with the associated run-on element 23A, 23B in the first position. FIGS. 12A-12D (as well as FIGS. 13A-13D and 14A-14D) show side views from four different spatial directions offset by 90° to each other.

In the first position of the adjustment elements 24A, 24B, a raised plateau 246 on the run-on portion 241 of the adjustment element 24A, 24B is in contact with the plateau 233 of the run-on element 23A, 23B, as can be seen in FIG. 12A.

If the adjustment element 24A, 24B on the housing part 20 is rotated out of the first position, a ramp section 245 of the run-on section 241 runs onto the ramp 234 on the run-on element 23A, 23B (FIGS. 13A-13D) until the plateau 246 on the run-on section 241 abuts against the plateau 235 on the run-on element 23A, 23B, as can be seen from FIGS. 14A-14D. Twisting thus increases an axial distance between the adjustment elements 24A, 24B and the run-on elements 23A, 23B, so that the adjustment elements 24A, 24B are adjusted axially in the closing direction X on the housing part 20 and thus an elastic prestressing force is provided by elastic deformation of the resilient elements 22A, 22B.

In particular, the adjustment elements 24A, 24B draw the engagement elements 31A, 31B into engagement with the insertion openings 200A, 200B in the closing direction X by their axial adjustment during rotation, so that the engagement elements 31A, 31B are axially pretensioned in the closing direction X and the locking parts 2, 3 are thus held together essentially without play under axial pretension. In this way, a particularly secure, firm, backlash-free and rattle-free hold of the locking parts 2, 3 against each other is produced, which enables a secure, reliable, vibration-proof hold of the locking parts 2, 3 against each other during operation.

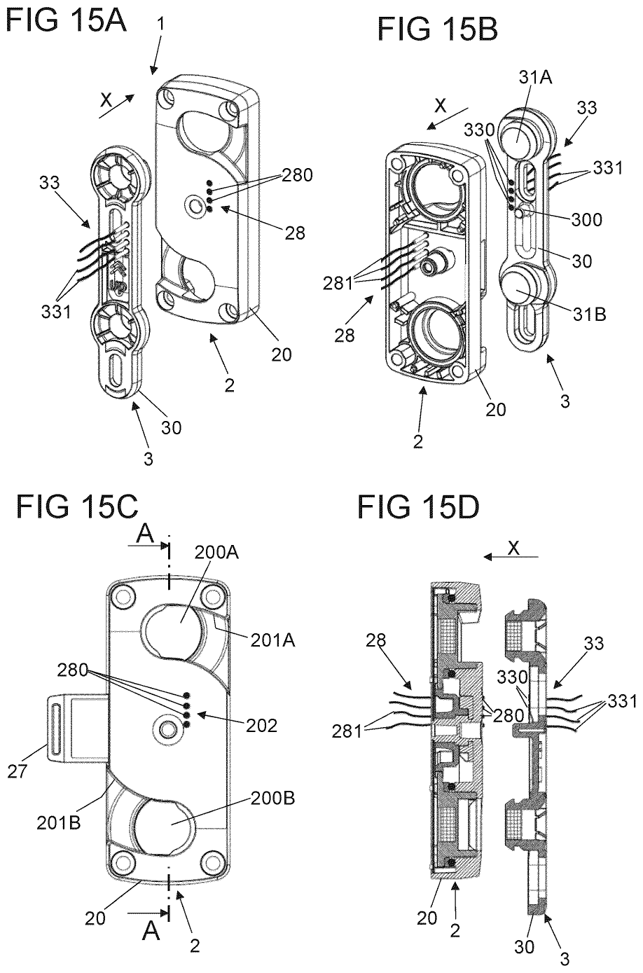

In the exemplary and non-limiting embodiment described above, the locking device 1 can be configured as an electrical locking device with electrical contacts, so that an electrical connection is (also) established when the locking parts 2, 3 are connected. This is illustrated by the non-limiting embodiments shown in FIGS. 15A-15D to 17.

The exemplary and non-limiting embodiment according to FIGS. 15A-15D corresponds functionally to the exemplary and non-limiting embodiment of the locking device 1 according to FIGS. 1 to 14A-14D, so that reference is made to the preceding explanations for the functional design of the locking device 1.

In the illustrated exemplary and non-limiting embodiment, contact arrangements 28, 33 are additionally arranged on the locking parts 2, 3, which are formed by contact elements 280, 330 on the respective housing parts 20, 30. If the locking parts 2, 3 are attached to one another along the closing direction X to close the locking device 1, the contacts 28, 33 come into electrical contact with each other, so that a four-pole electrical connection (in the exemplary and non-limiting embodiment shown) is established between the contact arrangements 28, 33. Lines 281, 331 are thus electrically connected to each other so that currents can be transmitted, for example for transmitting control signals or an electrical supply current.

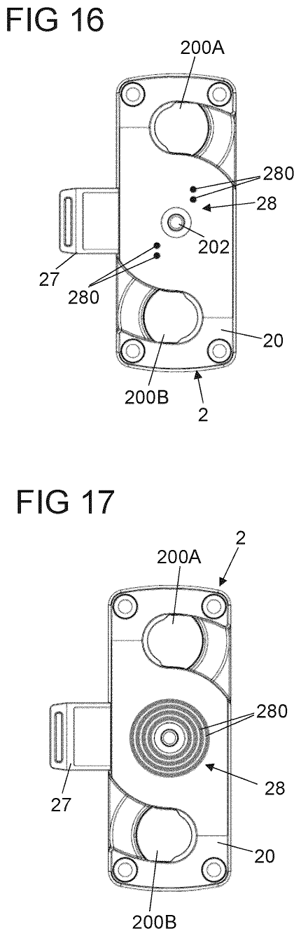

The non-limiting embodiments according to FIG. 16 and FIG. 17 differ in the arrangement of the electrical contacts 280 on the housing part 20 of the locking part 2 (wherein the locking part 3 has correspondingly arranged contacts 330 on the housing 30). In the exemplary and non-limiting embodiment according to FIG. 16, two pairs of contacts 280 are arranged diametrically opposite the engagement opening 202 on the housing part 20. In the exemplary and non-limiting embodiment according to FIG. 17, the contacts 280 are formed by ring-shaped contacts.

In all of the non-limiting embodiments herein, any number of contacts 280, 330 may be provided, for example two, three, four, seven or even more contacts.

In the exemplary and non-limiting embodiment shown in FIGS. 1 to 14A-14D, the insertion openings 200A, 200B are opened laterally through exit openings 201A, 201B, so that the locking parts 2, 3 can be opened relative to one another by rotating them about the central axis of rotation D. By rotating the locking parts 2, 3 about the axis of rotation D, the engagement elements 31A, 31B pass through the exit openings 201A, 201B and out of the insertion openings 200A, 200B, so that the engagement of the engagement protrusions 243, 310 is canceled and the locking device 1 is thus opened.

In the exemplary and non-limiting embodiment according to FIGS. 1 to 14A-14D, the exit openings 201A, 201B are arranged on different sides of the housing part 20, so that the insertion openings 200A, 200B are open in opposite directions. The exit openings 201A, 201B are diametrically opposed to the axis of rotation D formed at the engagement opening 202. This enables the locking parts 2, 3 to be rotated relative to one another about the axis of rotation D in order to move the engagement elements 31A, 31B through the exit openings 201A, 201B and thus open the locking device 1.

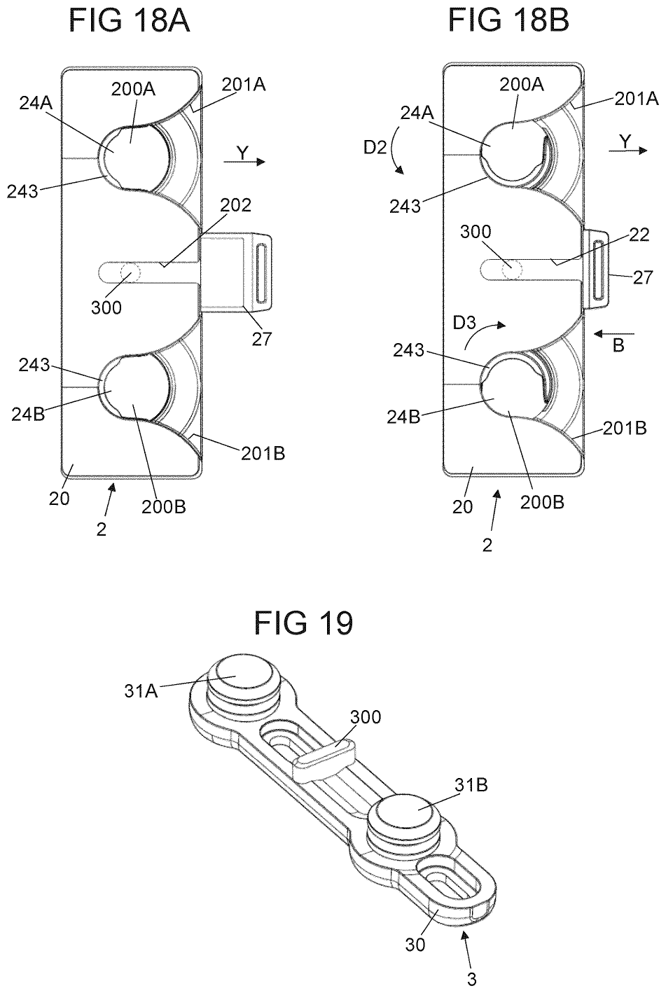

While in the exemplary and non-limiting embodiment according to FIGS. 1 to 14A-14D, the locking device 1 is opened by rotating the locking parts 2, 3 about the axis of rotation D relative to each other, it is also conceivable to design the locking device 1 in such a way that the closure direction 1 can be opened by parallel displacement of the locking parts 2, 3. This is illustrated in FIGS. 18A and 18B.

In this exemplary and non-limiting embodiment, the insertion openings 200A, 200B are opened by exit openings 201A, 201B which are arranged in the same direction on the same side of the housing part 20 and enable the second locking part 3 to be displaced by parallel displacement in the opening direction Y to the housing part 2 in order to remove the engagement elements 31A, 31B of the second locking part 3 from the insertion openings 200A, 200B in the opening direction Y in this way.

Again, adjustment elements 24A, 24B are arranged at the insertion openings 200A, 200B, which are rotatably mounted on the housing part 20 and are operatively connected to an actuating element 27 in such a way that the adjustment elements 24A, 24B can be adjusted in directions of rotation D2, D3 from the first position (FIG. 18A) to the respectively associated second position (FIG. 18B) by linear adjustment of the actuating element 27 in an actuating direction B.

The actuating element 27 can be arranged on the side of the housing part 20 associated with the exit openings 201A, 201B, as in the illustrated exemplary and non-limiting embodiment. However, the actuating element 27 can also be arranged on the other, averted side (on the left in FIGS. 18A, 18B) of the housing part 20.

In the exemplary and non-limiting embodiment shown, the engagement opening 202 on the housing part 20 is formed by an elongated hole open in the opening direction Y, into which the second locking part 3 engages with the bearing pin 300 when the locking device 1 is closed. When the locking parts 2, 3 are displaced parallel to one another, the bearing pin 300 in the engagement opening 202 is adjusted in the opening direction Y, so that the displacement movement of the locking parts 2, 3 relative to one another is guided by this.

In the exemplary and non-limiting embodiments described above, the bearing pin 300 is formed by a cylindrical pin. However, as illustrated in FIG. 19, in the exemplary and non-limiting embodiment of the locking device 1 according to FIGS. 18A, 18B, the bearing pin 300 can also be configured as a longitudinally extended web, which creates an improved longitudinal guide for guiding the displacement movement in the opening direction Y for the adjustment part 3.

Otherwise, in particular with regard to the function of the adjustment elements 24A, 24B, reference is made to the preceding explanations of the exemplary and non-limiting embodiment according to FIGS. 1 to 14A-14D.

The idea underlying the solution is not limited to the non-limiting embodiments described above, but can also be realized in other ways.

A locking device of the type described can be used, for example, on a vehicle such as a bicycle, e.g. an electrically powered color wheel (e-bike).

For example, a locking device of the type described can be used to connect an electrical assembly to a bicycle frame, for example to detachably connect a battery assembly to the bicycle frame.

As in the exemplary and non-limiting embodiments shown, the locking device can be configured as a magnetic locking device with magnetic elements. However, it is also conceivable to design the locking device as a purely mechanical locking device without magnetic elements.

In the exemplary and non-limiting embodiments shown, an adjustable positioning element is provided at each slot to prevent the locking parts from being released. However, it is also conceivable and possible to provide an adjustable positioning element at only one slot, but not at the other one.

1. A locking device for connecting two assemblies to one another, comprising:
a first locking part which is associated with a first one of the assemblies and comprises a housing part and two slots each having at least one first engagement protrusion, wherein at least one of the slots comprises an adjustment element which can be adjusted relative to the housing part, and
a second locking part which is associated with a second one of the assemblies and comprises two engagement elements each having at least one second engagement protrusion,
wherein, for closing the locking device, each of the engagement elements of the second locking part can be attached to one of the slots of the first locking part, the first engagement protrusions are engaged with the second engagement protrusions in a closed position for holding the first locking part and the second locking part against one another against the closing direction, and the first locking part and the second locking part can be separated from one another for opening the locking device, wherein the first locking part and the second locking part are movable relative to one another along a movement plane perpendicular to the closing direction for opening the locking device,
wherein the adjustment element is arranged on the housing part of the first locking part so as to be adjustable between a first position and a second position, wherein, in the first position, the adjustment element is configured to enable the first locking part and the second locking part to be attached to one another along a closing direction for closing the locking device and, in the second position, to block movement of the first locking part and the second locking part along the movement plane relative to one another and thereby blocking an opening of the locking device.

2. The locking device according to claim 1, wherein each of the slots comprises an adjustment element, wherein
the adjustment elements are jointly adjustable via an actuating mechanism of the first locking part or
the adjustment elements are adjustable independently of one another.

3. (canceled)

4. The locking-device according to claim 1, wherein one of the first locking part and the second locking part comprises a bearing pin and the other of the first locking part and the second locking part comprises an engagement opening, wherein the bearing pin engages in the engagement opening in the closed position and the first locking part and, as a result, the second locking part are supported against each other.

5. The locking device according to claim 1, wherein,
in order to open the locking device, the first engagement protrusions and the second engagement protrusions can be disengaged from one another by pivoting the first locking part and the second locking part along the movement plane relative to one another, or
for opening the locking device, the first engagement protrusions and the second engagement protrusions can be disengaged from one another by parallel displacement of the first locking part and the second locking part along the movement plane relative to one another.

6. (canceled)

7. The locking device according to claim 1, wherein the at least one first engagement protrusion of the at least one of the slots is arranged on the adjustment element and can be adjusted together with the adjustment element relative to the housing part.

8. The locking device according to claim 1, wherein the adjustment element comprises a base and a collar portion rigidly formed on the base and projecting from the base along the closing direction.

9. (canceled)

10. (canceled)

11. The locking device according to claim 1, wherein the first engagement protrusions and the second engagement protrusions are engaged with one another in a form-fit manner in the closed position.

12. The locking device according to claim 1, wherein the first locking part and the second locking part can be attached to one another exclusively in the first position of the adjustment element for closing the locking device.

13. The locking device according to claim 1, wherein the adjustment element is rotatable between the first position and the second position relative to the housing part of the first locking part.

14. The locking device according to claim 1, wherein the adjustment element can be rotated between the first position and the second position about an associated axis of rotation, which is directed parallel to the closing direction, relative to the housing part.

15. The locking device according to claim 1, wherein at least one of:
the adjustment element, when the first locking part and the second locking part are attached to one another, can be transferred from the first position to the second position in order to apply, in the second position in each case, a pretensioning force to the associated engagement element along the closing direction, and
the adjustment element, in the first position, is in a first axial position relative to the housing part and, in the second position, in a second axial positon relative to the housing part, which differs from the first axial position and is offset along the closing direction.

16. (canceled)

17. The locking device according to claim 1, wherein the first locking part comprises, at the at least one of the slots, a run-on element arranged on the housing part and having a first ramp section, and the adjustment element comprises a run-on section with a second ramp section, wherein the first ramp section slides on the second ramp section when the adjustment element is adjusted for axial adjustment of the associated adjustment element.

18. The locking device according to claim 17, wherein at least one of:
the run-on element is connected to the housing part in a co-rotational manner, and
at least one of the first locking part and the second locking part comprises at least one elastically deformable resilient element which is elastically deformable upon axial displacement of the adjustment element.

19. (canceled)

20. (canceled)

21. The locking device according to claim 1, wherein the first locking part comprises an actuating element which can be actuated in order to move the adjustment element between the first position and the second position.

22. (canceled)

23. The locking device according to claim 1, wherein the first locking part comprises a drive element which is operatively connected to the adjustment element and which is configured to introduce an adjusting force into the adjustment element when actuated.

24. The locking device according to claim 23, wherein at least one of:
the drive element is arranged rotatably on the housing part,
the drive element comprises a first toothed portion which is in toothed engagement with a toothed portion of an actuating element, and
the drive element comprises a second toothed portion which is in toothed engagement with a toothed portion of the adjustment element.

25. (canceled)

26. (canceled)

27. The locking device according to claim 1, wherein the housing part comprises an insertion opening at each slot, into each of which an engagement element of the second locking part can be inserted along the closing direction for closing the locking device.

28. The locking device according to claim 27, wherein at least one of:
each insertion opening is opened through an exit opening in an opening direction directed transversely to the closing direction, wherein, in the first position of the adjustment element, the engagement elements are movable out of the insertion openings in the opening direction, for opening the locking device, and
the adjustment element associated with at least one of the slots blocks the exit opening in the second position in such a way that the associated engagement element cannot be moved out of the insertion opening in the opening direction for opening the locking device.

29. (canceled)

30. The locking device according to claim 1, wherein the first locking part comprises a first magnetic element and the second locking part comprises a second magnetic element, wherein the first magnetic element and the second magnetic element magnetically attractively cooperate to magnetically support the attachment of the first locking part and the second locking part for closing the locking device.

31. The locking device according to claim 1, wherein in the first locking part comprises a first electrical contact arrangement and the second locking part comprises a second electrical contact arrangement, wherein the first electrical contact arrangement and the second electrical contact arrangement are operatively connected to one another in an electrically contacting manner in the closed position.
